(19) United States
(12) Patent Application Publication
(10) Pub. No.: US 2021/0385510 A1
(43) Pub. Date: Dec. 9, 2021

(54) LIVE STREAM PLAYBACK VIDEO GENERATION METHOD, DEVICE AND APPARATUS

(71) Applicant: Beijing Dajia Internet Information Technology Co., Ltd., Beijing (CN)

(72) Inventors: Xiangbo HE, Beijing (CN); Xian LI, Beijing (CN); Haitao DU, Beijing (CN)

(21) Appl. No.: 17/405,652

(22) Filed: Aug. 18, 2021

Related U.S. Application Data
(63) Continuation of application No. PCT/CN2020/074231, filed on Feb. 3, 2020.

(30) Foreign Application Priority Data
Mar. 28, 2019 (CN) 201910245736.8

(51) Int. Cl. H04N 21/2387; H04N 21/2187; H04N 21/234; H04N 21/231

(52) U.S. Cl. CPC H04N 21/2387; H04N 21/231; H04N 21/23424; H04N 21/2187

(57) ABSTRACT

The present application relates to a live stream playback video generation method, device and apparatus. The method includes: obtaining target data corresponding to live stream in a live stream playing process; judging whether the live stream anchor generates a live stream playback video according to the target data; when the judgment result is that the live stream anchor can generate the live stream playback video, generating first playback data based on the live stream data generated before the reference time point, and generating second playback data based on the live stream data generated after the reference time point in real time; the reference time point is a time point at which the judgment result is obtained; after receiving a live stream playback video generation instruction, generating a live stream playback video based on the first playback data and the second playback data.

### CROSS-REFERENCE OF RELATED APPLICATIONS

The application is a continuation application of International Application No. PCT/CN2020/074231, filed on Feb. 3, 2020, which is based on and claims the priority of Chinese Patent Application No. 201910245736.8, filed with the China National Intellectual Property Administration on Mar. 28, 2019, both of which are hereby incorporated by reference in their entirety.

### FIELD OF INVENTION

The application relates to the field of live stream technology, and in particular to a method, a device and an apparatus for generating a playback video of a live stream.

### BACKGROUND

With the development of Internet technology, the live stream that enables the anchor and the viewer to interact in real-time via video is becoming more and more popular. Due to the real-time nature of the live stream, if a customer does not watch a live stream on time, he may miss the live content before the time point at which he starts to watch the live stream or miss all the live content of the live stream. Therefore, there is a need to generate a playback video of the live stream in order to meet the user's demand for watching the missed live content.

In related technology, the method of generating the playback video may include: the server of the live stream system generates the playback data of the live stream during the live stream; wherein the playback data may include the video segments that are obtained by transcoding the live video stream in real time and stored, and the indexes of the video segments; when the live stream ends, if the server receives the playback generation instruction sent by the anchor through the anchor client, the server will generate the playback video corresponding to the playback generation instruction by using the playback data.

However, the inventors found that the server will generate the playback data for each live stream to ensure the generation rate of the playback video in the above method for generating the playback video. In specific application, the anchor may only have an intention to generate the playback video for a part of the live streams, so that the playback data of only a part of the live streams is used to generate the playback video. Therefore, if the above method for generating the playback video is adopted, the related playback data is redundant for the live stream about which the anchor has no intention to generate the playback video. Such redundant playback data will waste the data processing resources and storage resources.

As can be seen, how to reduce the waste of data processing and storage resources caused by the playback data of the live stream is an urgent problem to be solved in the live stream technology.

### BRIEF SUMMARY

In order to overcome the problem in the related technology, the application provides a method, a device and an apparatus for generating a playback video of a live stream.

According to a first aspect of the embodiments of the application, there is provided a method for generating a playback video of a live stream applied to a server of a live stream system, where the method includes:

obtaining target data corresponding to the live stream in a playing process of the live stream;

determining whether an anchor of the live stream has a willingness to generate a playback video of the live stream based on the target data;

in a case that a determining is that the anchor of the live stream has the willingness to generate the playback video of the live stream, generating first playback data based on live stream data generated before a reference time point, and generating second playback data in real time based on live stream data generated after the reference time point; wherein the reference time point is a time point at which the determining result is obtained;

generating the playback video of the live stream based on the first playback data and the second playback data in response to that an instruction for generating the playback video of the live stream is received.

According to a second aspect of the embodiments of the application, there is provided a device for generating a playback video of a live stream applied to a server of a live stream system, where the device includes:

a data acquisition module configured to obtain target data corresponding to the live stream in a playing process of the live stream;

a playback determining module configured to determine whether an anchor of the live stream has a willingness to generate a playback video of the live stream based on the target data;

a playback generation module configured, in a case that a determining result is that the anchor of the live stream has the willingness to generate the playback video of the live stream, to generate first playback data based on live stream data generated before a reference time point, and generate second playback data in real time based on live stream data generated after the reference time point; wherein the reference time point is a time point at which the determining result is obtained; and generate the playback video of the live stream based on the first playback data and the second playback data in response to that an instruction for generating the playback video of the live stream is received.

According to a third aspect of the embodiments of the application, a server is provided, including:

a processor,

a memory for storing instructions that can be executed by the processor;

wherein the execution of the instructions causes processor is configured to: implement any method for generating the playback video of the live stream described in the above first aspect when executing the executable instructions stored in the memory.

According to a fourth aspect of the embodiments of the application, a non-transitory computer-readable storage medium is provided. When the instructions in the storage medium are executed by a processor of a server, the server performs any method for generating the playback video of the live stream described in the above first aspect.

According to a fifth aspect of the embodiments of the application, there is provided a computer program product, which causes a server to perform any method for generating the playback video of the live stream described in the above first aspect when running on the server.

It should be understood that the above general description and the following detailed description are only exemplary and illustrative, and cannot limit the application.

### BRIEF DESCRIPTION OF THE DRAWINGS

FIG. 1 is a flow chart of a method for generating a playback video of a live stream shown according to an embodiment.

FIG. 2 is a flow chart of a method for generating a playback video of a live stream shown according to another embodiment.

FIG. 3 is a flow chart of a method for generating a playback video of a live stream shown according to yet another embodiment.

FIG. 4 is a block diagram of a device for generating a playback video of a live stream shown according to an embodiment.

FIG. 5 is a block diagram of a server shown according to an embodiment.

FIG. 6 is a block diagram of a server shown according to another embodiment.

### DETAILED DESCRIPTION OF THE EMBODIMENTS

FIG. 1 is a flow chart of a method for generating a playback video of a live stream shown according to an embodiment. As shown in FIG. 1, a method for generating a playback video of a live stream applied to a server of a live stream system may include the following steps.

S101: obtaining target data corresponding to the live stream in a playing process of the live stream.

Here, the target data is the data that can reflect the degree of willingness of the anchor to allow the generation of the playback video of the live stream. Since the anchor's willingness to allow the generation of the playback video of the live stream can be reflected from various aspects, there may be many kinds of target data.

In some embodiments, the target data includes at least one of: the behavior data of the anchor of the live stream and the popularity data reflecting the popularity degree of the live stream, wherein the behavior data of the anchor of the live stream may exemplarily include at least one of: the time of the live stream performed by the anchor, the anchor's topic description for the live stream, and the interactive information of the anchor on whether to generate the playback video of the live stream, ect., for example, at least one piece of the following data: the anchor starts the live stream at 20:30, the anchor describes the topic of the live stream as “Live stream of upgrade of game A”, and the anchor answers the question from the audience in the comments of the live stream or informs by himself that “this live stream has a playback” or “this live stream has no playback”. Exemplarily, the popularity data reflecting the popularity degree of the live stream may include at least one of: the number of comments of the live stream, the number of likes, the number of gifts, the popularity value, and so on.

Correspondingly, different target data may be obtained in different ways. Exemplarily, the time of the live stream performed by the anchor may be the time stamp of the firstly generated video stream in reading the video stream of the live stream, or the start time of the video stream uploaded by the anchor may be taken as the time to perform the live stream. The anchor's topic description for the live stream may be directly reading the name of the live stream or extracting the anchor's comments on the topic description for the live stream from the comments of the live stream. The interactive information of the anchor on whether to generate the playback video of the live stream may be the comments on whether to generate the playback video extracted from the comments of the live stream. The popularity data of the live stream may be the number of comments, the number of likes, the number of gifts and the popularity value that have been counted and have been directly read, or may be obtained by statistics after the records related to the comments, likes and gifts of the live stream are obtained. The popularity value may be the calculated popularity value that has been directly read, or may be the popularity value which is calculated by the popularity value calculation formula based on the data, e.g., the number of comments, the number of likes, the number of gifts, etc., that has been read. Wherein the popularity value is a numerical value that characterizes the popularity degree of the live stream. Specifically, it may be a numerical value calculated using the preset popularity calculation formula based on the number of comments, the number of likes, the number of gifts, and the number of shares of the live stream, etc.

Any method that can obtain the above target data can be used in the application, and is not limited in the application.

In addition, the timing of obtaining the target data may be various, and may be specifically determined according to application requirements. For ease of understanding, the following description is given in the form of some embodiments.

In some embodiments, the timing of obtaining the target data may be a target time point which is a time point after a preset duration from the start time point of the live stream. For example, the preset duration is 30 minutes, the start time point of the live stream is 20:30, and the target time point is 21:00. Exemplarily, the preset duration may be the empirical duration during which the live stream's popularity data reaches the peak and which is determined based on the analysis of the related data of historical live streams; or may be the empirical duration during which the anchor presents the behavior included in the target data and which is determined based on the anchor's historical behavior data. Of course, since the time of the live stream performed by the anchor and the anchor's topic description for the live stream will generally not change over time, they can be obtained at any point in the live stream process.

In some embodiments, the timing of obtaining the target data may be: after obtaining the target data according to the foregoing embodiments of obtaining the target data, it is determined in the subsequent S102 that the determining result is not to generate and the live stream has not ended, and then the above S101 is performed to obtain the target data.

Regarding another optional timing of obtaining the target data described above, it can be understood that the target data may change with the progress of the live stream, which in turn affects the degree of willingness of the anchor to allow the generation of the playback video of the live stream reflected by these target data. For example, when the live stream is in progress for 20 minutes, the target data may reflect that the anchor does not allow the generation of the playback video of the live stream; and when the live stream is in progress for 30 minutes, the target data may reflect that the anchor allows the generation of the playback video of the live stream. Therefore, in order to avoid the misprediction of whether to generate the playback video of the live stream caused by the dynamic change of the target data, it is possible to obtain the target data when it is predicted that the playback video of the live stream will not be generated before the end of the live stream, to predict whether to generate the playback video of the live stream again. For example, when the live stream is in progress for 20 minutes, the target data is obtained, and the determining result determined by using the target data is that the playback video of the live stream is not generated, so the target data is obtained again. Therefore, through multiple predictions before the end of the live stream, it is possible to obtain the target data reflecting that the playback video of the live stream is allowed to be generated when the live stream is in progress for 30 minutes, thereby predicting the generation of the playback video of the live stream, avoiding the misprediction that playback video is not generated for the live stream, and improving the prediction accuracy.

It should be noted that any method of determining the timing at which the target data can be obtained can be used in the application, and is not limited in the application.

S102: determining whether the anchor of the live stream has a willingness to generate a playback video of the live stream based on the target data.

Here, there may be many ways to determine whether the anchor of the live stream has the willingness to generate the playback video of the live stream. Exemplarily, it is possible to determine whether the target data meets a preset playback condition; if so, it is determined that the determining result is to generate the playback video of the live stream; otherwise, it is determined that the determining result is not to generate the playback video of the live stream. Or exemplarily, the preset playback prediction algorithm may also be: inputting the target data into a preset neural network model to obtain the determining result on whether to generate the playback video of the live stream output by the preset neural network model; wherein the preset neural network model is a model trained by the sample target data of a plurality of sample live streams and the result labels on whether to generate playback videos corresponding to the sample live streams. The application does not limit the form and specific structure of the determining result of the preset neural network model; in addition, it can be understood that the sample target data of the sample live stream is of the same type as the target data corresponding to the live stream obtained in S101.

S103: in the condition that a determining result is that the anchor of the live stream has the willingness to generate the playback video of the live stream, generating the first playback data based on the live stream data generated before a reference time point, and generating the second playback data in real time based on the live stream data generated after the reference time point; where the reference time point is a time point at which the determining result is obtained.

Here, the live stream data used to generate the first playback data is the live stream content generated from the start of the live stream to the obtaining of the determining result. Exemplarily, a live stream starts at 20:30, and the determining result of the live stream obtained at 20:50 is to generate a playback video; then the live stream data used to generate the first playback data is the live content of the live stream between 20:30 and 20:50. In addition, said generating the first playback data based on the live stream data generated before the reference time point may specifically be: transcoding the live stream data generated before the reference time point into the first video segment, storing the first video segment, and creating a first index for searching for the first video segment, where the first playback data includes the stored first video segment and the first index.

The live stream data used to generate the second playback data is the live content generated from the time point at which the determining result is obtained to the time point at which the live stream ends, and the second playback data is generated in real time. Exemplarily, a live stream starts at 20:40, it is determined at 21:00 that the determining result of the live stream is to generate a playback video, and the live stream ends at 21:30, so the live stream data used to generate the second playback data is the live content of the live stream between 21:00 and 21:30. In addition, said generating the second playback data in real time based on the live stream data generated after the reference time point may specifically be: transcoding the live stream content generated from the time point at which the determining result is obtained to the time point at which the live stream ends into the second video segment in real time, storing the second video segment, and creating an index for searching for the second video segment, where the second playback data includes the stored second video segment and the second index.

S104: generating the playback video of the live stream based on the first playback data and the second playback data after receiving an instruction for generating the playback video of the live stream.

Here, the instruction for generating the playback video of the live stream may specifically be input by the anchor through a client. Since the first playback data and the second playback data are generated during the live stream process of the live stream for which the determining result is to generate the playback video before receiving the instruction for generating the playback video in the embodiment of the application, the playback video of the live stream can be directly generated based on the pre-generated first playback data and second playback data after receiving the instruction for generating the playback video of the live stream. Compared with the method of firstly generating the playback data of the live stream after receiving the instruction for generating the playback video of the live stream and then generating the playback video based on the playback data, the generation efficiency of the playback video is improved. In addition, since the pre-generated first playback data and second playback data are generated for the live stream for which the determining result is to generate the playback video, the generation of the redundant playback data that is not used to generate playback videos can be reduced and the waste of data processing resources and storage resources for the redundant playback data can be lowered compared with the playback video generation way in which the playback data is generated in real time for each live stream.

In some embodiments, generating the playback video of the live stream based on the first playback data and the second playback data may specifically include:

obtaining the playback video of the live stream by:

splicing the first playback data and the second playback data into the fourth playback data;

storing the fourth playback data; and

creating an index for searching for the fourth playback data.

Here, the splicing of the first playback data and the second playback data can specifically be: searching for a first video segment in the first playback data in accordance with the first index; and searching for a second video segment in the second playback data in accordance with the second index. The searched first video segment is spliced before the second video segment, so that the time axis of the occurrence of the video content in the third playback data is the same as the time axis of the live content.

Furthermore, in order to obtain the obtained playback video subsequently, there is a need to create an index for searching for the fourth playback data to search for the fourth playback data.

The technical solution provided by the embodiments of the application may include the following beneficial effects: in the live stream process, it is determined whether the anchor has the willingness to generate the playback video of the live stream, and the first playback data is generated based on the live stream data generated before the reference time point and the second playback data is generated in real time based on the live stream data generated after the reference time point in the condition that the determining result is to generate, wherein the reference time point is a time point at which the determining result is obtained; and then the playback video of the live stream is generated based on the first playback data and the second playback data after receiving the instruction for generating the playback video of the live stream. In the playing process of the live stream, it is determined whether the anchor of the live stream has the willingness to generate the playback video of the live stream, and then the playback data is generated in real time for the live stream of which the playback video is determined to be generated, so the generation of the redundant playback data that is not used to generate playback videos can be reduced and the waste of data processing resources and storage resources for the redundant playback data can be lowered compared with the playback video generation way in which the playback data is generated in real time for each live stream.

In some embodiments, after determining whether the anchor of the live stream has the willingness to generate the playback video of the live stream described above, the method for generating the playback video of the live stream of the embodiments of the application may further include:

in the condition that the determining result is that the anchor of the live stream does not have the willingness to generate the playback video of the live stream, generating the third playback data of the live stream if the instruction for generating the playback video of the live stream is received:

generating the playback video of the live stream based on the third playback data.

In the case that the anchor of the live stream does not have the willingness to generate the playback video of the live stream, the third playback data of the live stream will not be pre-generated in the live stream process, but the third playback data of the live stream is generated when the instruction for generating the playback video of the live stream is received. Therefore, compared with the pre-generation of the third playback data of the live stream for which the anchor does not have the willingness to generate the playback video, the generation of the redundant playback data of the live stream for which there is no need to generate a playback video can be avoided, and the waste of data processing resources and storage resources for the redundant playback data can be lowered.

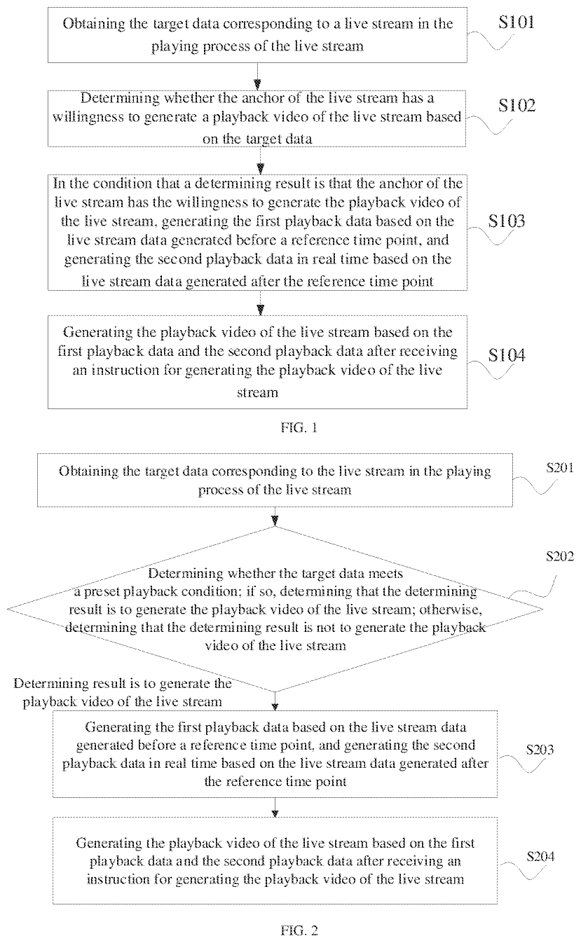

FIG. 2 is a flow chart of a method for generating a playback video of a live stream shown according to another embodiment. As shown in FIG. 2, the method may include the following steps.

S201: obtaining the target data corresponding to the live stream in the playing process of the live stream.

S201 is the same as S101 in the above embodiment of FIG. 1 of the application, and will not be repeated here. For details, the reference is made to the description of the embodiment of FIG. 1 of the application.

S202: determining whether the target data meets a preset playback condition; if so, determining that the determining result is to generate the playback video of the live stream; otherwise, determining that the determining result is not to generate the playback video of the live stream. When the determining result is yes, S203 to S204 are performed.

In specific applications, there are various preset playback conditions, which can be specifically set according to the target data. Exemplarily, the target data includes: three kinds of behavioral data: the start time at which the anchor starts to perform the live stream, the anchor's topic description for the live stream, and the interactive information of the anchor on whether to generate the playback video of the live stream; and four kinds of popularity data: the number of comments, the number of likes, the number of gifts, and the popularity value. For example, the preset playback condition corresponding to the start time of the live stream performed by the anchor may be: the start time is the same as the historical start time of the existing playback video corresponding to the anchor. The preset playback condition corresponding to the anchor's topic description for the live stream may be: the topic description is the same as the historical topic of the existing playback video corresponding to the anchor. The preset playback condition corresponding to the interactive information of the anchor on whether to generate the playback video of the live stream may be: the interactive information is the information indicating that the playback video of the live stream is to be generated. The preset playback condition corresponding to the number of comments may be that the number of comments is not less than the preset threshold of the number of comments; the preset playback condition corresponding to the number of likes may be that the number of likes is not less than the preset threshold of the number of likes; the preset playback condition corresponding to the number of gifts may be that the number of gifts is not less than the preset threshold of the number of gifts; and the preset playback condition corresponding to the popularity value may be that the popularity value is not less than the preset popularity threshold.

Here, there may be a certain rule in the time of the live stream performed by the anchor. Thus, the historical start time of the existing playback video corresponding to the anchor may be taken as the determining basis. When the start time of the live stream performed by the anchor is the same as the historical start time of the existing playback video corresponding to the anchor, the preset playback condition is met. Exemplarily, the historical start time of the existing playback video corresponding to the anchor is 20:30 every Saturday or every Friday. If the start time of a certain live stream of the anchor is 20:30 on Saturday or Friday, then it is highly possible that the anchor allows the generation of a playback video of the live stream, so the preset playback condition is met. It can be understood that the number of existing playback videos of which the historical times can be used as the preset playback condition is usually plural, so as to be able to analyze the rule that the anchor allows the generation of playback videos.

The live stream topics of the anchor may belong to the same series. In the existing historical live streams of the anchor, if a playback video is generated for a live stream with a certain topic, then it is highly possible to also generate a playback video for a live stream with the same topic. Therefore, the historical topic of the existing playback video of the anchor can be used as the determining basis to obtain the anchor's topic description for the live stream. The corresponding preset playback condition is: the topic description is the same as the historical topic of the existing playback video corresponding to the anchor. Exemplarily, the historical topics of the existing playback videos corresponding to the anchor A are “Live stream of upgrade of game A for the 120^{th} time” and “First part of live stream of teaching for game B”. If the topic of a certain live stream is “Live stream of upgrade of game A for the 121^{th} time” or “Second part of live stream of teaching for game B”, that is, the topic description for the live stream is “Upgrade of game A” or “Teaching for game B”, so the topic description for the live stream is the same as the historical topic of the existing playback video corresponding to the anchor, then the preset playback condition is met.

The interactive information between the anchor and the audience may also indicate whether to generate the playback video of the live stream, so the interactive information of the anchor on whether to generate the playback video of the live stream may be taken as the determining basis. When the interactive information indicates that the playback video is generated, the preset playback condition is met, wherein the interactive information may be the anchor's comment on the live stream or the answer to the question of the audience of the live stream, and may be described in the form of text or in the form of voice during the live stream. Exemplarily, the anchor foreshows in the comment of the live stream that “there is a playback video of this live stream”, and the interactive information indicates that the playback video is to be generated and the preset playback condition is met.

The preset playback condition corresponding to various popularity data may specifically be set according to the relevant popularity data of the anchor's historical live streams of which the playback videos are generated.

It should be noted that the above preset playback conditions corresponding to various target data are only exemplary, and any playback condition that can determine whether to generate a playback video based on the target data of the live stream corresponding to the anchor can be taken as the preset playback condition in the application, which is not limited in this embodiment.

When there are many kinds of target data, these kinds of target data are independent of each other, for example, the time at which the live stream is performed may affect neither the anchor's description of the live stream topic nor the interactive information of the anchor on whether to generate the playback video of the live stream, so the fact that a kind of target data meets the preset playback condition corresponding to this kind of target data indicates that the anchor has the willingness to generate the playback video of the live stream. Therefore, when there are many kinds of target data, it is necessary for each kind of target data to determine whether this kind of target data meets the preset playback condition corresponding to this kind of target data. If this kind of target data meets the preset playback condition corresponding to this kind of target data, S203 can be performed. Conversely, if each kind of target data does not meet the preset playback condition corresponding to this kind of target data, it indicates that the anchor has no willingness to generate a playback video. At this time, S204 can be performed. It can be understood that if one of these kinds of target data does not meet its condition, then continue to determine whether the target data that has not been determined meets the preset playback condition corresponding to this kind of behavior data, until it is determined that one kind of target data meets its condition; or none of these kinds of target data meets condition, the determining result can be obtained. For example, if it is determined that the start time of the live stream performed by the anchor does not meet the condition A, then it is determined whether the anchor's topic description for the live stream meets the condition B; if the condition B is not met, then it is determined whether the interactive information of the anchor on whether to generate the playback video of the live stream meets the condition C. If the condition C is met, the determining result is to generate the playback video; if the condition C is not met, the determining result is not to generate the playback video.

S203: generating the first playback data based on the live stream data generated before a reference time point, and generating the second playback data in real time based on the live stream data generated after the reference time point.

S204: generating the playback video of the live stream based on the first playback data and the second playback data after receiving an instruction for generating the playback video of the live stream.

S203 to S204 are the same as S103 to S104 in the above embodiment of FIG. 1 of the application, and will not be repeated here. For details, the reference is made to the description of the above embodiment of FIG. 1 of the application.

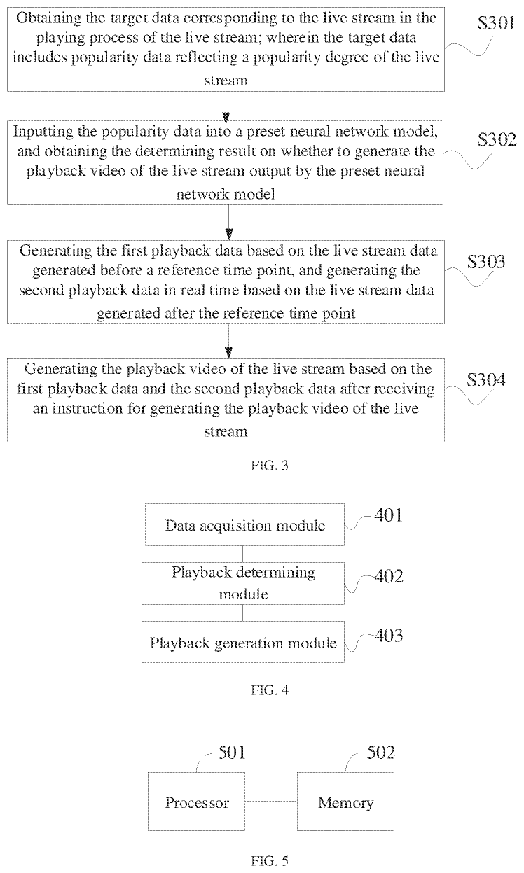

FIG. 3 is a flow chart of a method for generating a playback video of a live stream shown according to yet another embodiment. As shown in FIG. 3, the method may include the following steps.

S301: obtaining the target data corresponding to a live stream in the playing process of the live stream.

S301 is the same as S101 in the above embodiment of FIG. 1 of the application, and will not be repeated here. For details, the reference is made to the description of the embodiment of FIG. 1 of the application.

S302: obtaining the determining result on whether to generate the playback video of the live stream output by a preset neural network model, by inputting the target data into the preset neural network model, wherein the preset neural network model is a model trained by sample target data of a plurality of sample live streams and result labels on whether to generate playback videos corresponding to the sample live streams. When the determining result is to generate the playback video of the live stream, S303 to S304 are performed.

Since the preset neural network model is a model trained by sample target data of a plurality of sample live streams and result labels on whether to generate playback videos corresponding to the sample live streams, the target data is input into the preset neural network model, and the preset neural network model can extract the characteristic of whether to generate a playback video reflected by the target data, evaluate the degree of confidence of the input target data belonging to the target data for generating the playback video, and then use the degree of confidence to obtain the determining result on whether to generate the playback video of the live stream.

S303: generating the first playback data based on the live stream data generated before a reference time point, and generating the second playback data in real time based on the live stream data generated after the reference time point.

S304: generating the playback video of the live stream based on the first playback data and the second playback data after receiving an instruction for generating the playback video of the live stream.

S303 to S304 are the same as S103 to S104 in the above embodiment of FIG. 1 of the application, and will not be repeated here. For details, the reference is made to the description of the above embodiment of FIG. 1 of the application.

Since whether to generate a playback video is usually decided by the anchor, the behavior data can accurately reflect the anchor whether has the willingness to generate the playback video when the behavior data is used to determine whether to generate the playback video, thereby reducing the difference between the determining result obtained by using the behavior data and the anchor's actual demand on whether to generate the playback video, improving the accuracy of the determination of whether to generate the playback video, reducing the increase in redundant data caused after the playback data is pre-generated for the live streams of which the playback videos don't have to be generated due to the wrong determination, and also reducing the decrease in the efficiency of the generating for the playback video caused by not generating the playback data for the live streams of which the playback videos need to be generated due to the wrong determination.

In specific applications, there is also a situation where the anchor had no willingness to generate a playback video of the live stream initially, but the good popularity data of the live stream makes the live stream have the value of being generated to the playback video, causing the anchor to change the willingness. Therefore, when it is determined whether to generate a playback video, the popularity data of the live stream itself can be used as the analysis basis. In addition, there are also such live streams in the sample live streams that the anchor changed the willingness to be to generate playback videos due to the popularity of the live streams. Thus, when the popularity data is used as the target data to determine whether to generate a playback video, the popularity data can not only reflect the anchor's willingness on whether to generate a playback video, but also reflect whether the live stream has the value of being generated to the playback video, so that the live stream of which the playback value cannot be determined depending on the behavior data reflecting the anchor's generation willingness and for which the anchor had no willingness to generate a playback video initially can be determined out, improving the accuracy of the determination on the playback video, reducing the increase in redundant data caused after the playback data is pre-generated for the live streams of which the playback videos don't have to be generated due to the wrong determination, and also reducing the decrease in playback video generation efficiency caused by not generating the playback data for the live streams of which the playback videos need to be generated due to the wrong determination.

Corresponding to the foregoing method embodiments, the application further provides a device for generating a playback video of a live stream.

FIG. 4 is a block diagram of a device for generating a playback video of a live stream shown according to an embodiment. Referring to FIG. 4, this device, which is applied to the server of the live stream system, includes a data acquisition module 401, a playback determining module 402 and a playback generation module 403.

The data acquisition module 401 is configured to obtain the target data corresponding to the live stream in the playing process of the live stream.

The playback determining module 402 is configured to determine whether the anchor of the live stream has a willingness to generate the playback video of the live stream based on the target data.

The playback generation module 403 is configured, in the condition that the determining result is that the anchor of the live stream has the willingness to generate the playback video of the live stream, to generate the first playback data based on the live stream data generated before a reference time point, and generate the second playback data in real time based on the live stream data generated after the reference time point; where the reference time point is a time point at which the determining result is obtained; and generate the playback video of the live stream based on the first playback data and the second playback data after receiving an instruction for generating the playback video of the live stream.

The technical solution provided by the embodiment of the application may include the following beneficial effects: in the playing process of the live stream, it is determined whether the anchor of the live stream has the willingness to the playback video of the live stream, and then the playback data is generated in real time for the live stream of which the playback video will be generated, so the generation of the redundant playback data that is not used to generate playback videos can be reduced and the waste of data processing resources and storage resources for the redundant playback data can be lowered compared with the playback video generation way in which the playback data is generated in real time for each live stream.

In some embodiments, the above playback generation module 403 is further configured to generate third playback data of the live stream in the condition that the determining result is that the anchor of the live stream does not have the willingness to generate the playback video of the live stream and the instruction for generating the playback video of the live stream is received; and generate the playback video of the live stream based on the third playback data.

In some embodiments, the above target data includes at least one of: the behavior data of the anchor of the live stream, or the popularity data reflecting the popularity degree of the live stream.

In some embodiments, the above playback determining module 402 is configured to:

determine whether the target data meets a preset playback condition;

if so, determine that the determining result is to generate the playback video of the live stream; otherwise, determine that the determining result is not to generate the playback video of the live stream.

In some embodiments, the playback determining module 402 is configured to:

input the target data into a preset neural network model:

obtaining the determining result on whether to generate the playback video of the live stream output by the preset neural network model; wherein the preset neural network model is a model trained by the sample target data of a plurality of sample live streams and the result labels on whether to generate playback videos corresponding to the sample live streams.

In some embodiments, the data acquisition module 401 is configured to: obtain the target data corresponding to the live stream in the playing process of the live stream in the condition that the determining result of the playback determining module 402 is not to generate and the live stream has not ended.

In some embodiments, the playback generation module 403 is configured to:

obtain the playback video of the live stream by:

splicing the first playback data and the second playback data into the fourth playback data;

storing the fourth playback data; and

create an index for searching for the fourth playback data.

Regarding the device in the above embodiment, the specific manner in which each module performs the operations has been described in detail in the embodiment related to the method, and will not be illustrated in detail here.

Corresponding to the foregoing method embodiments, the application further provides a server.

FIG. 5 is a block diagram of a server shown according to an embodiment. Referring to FIG. 5, the server may include:

a processor 501;

a memory 502 for storing instructions that can be executed by the processor:

wherein the processor 501 is configured to:
obtain the target data corresponding to the live stream in the playing process of the live stream;
determine whether the anchor of the live stream has a willingness to generate a playback video of the live stream based on the target data;
in the condition that a determining result is that the anchor of the live stream has the willingness to generate the playback video of the live stream, generate the first playback data based on the live stream data generated before a reference time point, and generate the second playback data in real time based on the live stream data generated after the reference time point; wherein the reference time point is a time point at which the determining result is obtained;
generate the playback video of the live stream based on the first playback data and the second playback data after receiving an instruction for generating the playback video of the live stream.

In some embodiments, the processor 501 is further configured to generate third playback data of the live stream in the condition that the determining result is that the anchor of the live stream does not have the willingness to generate the playback video of the live stream and the instruction for generating the playback video of the live stream is received; and generate the playback video of the live stream based on the third playback data.

In some embodiments, the target data includes at least one of: the behavior data of the anchor of the live stream and the popularity data reflecting the popularity degree of the live Stream.

In some embodiments, the processor 501 is further configured to:

determine whether the target data meets a preset playback condition:

if so, determine that the determining result is to generate the playback video of the live stream; otherwise, determine that the determining result is not to generate the playback video of the live stream.

In some embodiments, the processor 501 is specifically configured to:

input the target data into a preset neural network model to obtain the determining result on whether to generate the playback video of the live stream output by the preset neural network model; wherein the preset neural network model is a model trained by the sample target data of a plurality of sample live streams and the result labels on whether to generate playback videos corresponding to the sample live streams.

In some embodiments, the processor 501 is configured to: obtain the target data corresponding to the live stream in the playing process of the live stream in the condition that the determining result of the playback determining module is not to generate and the live stream has not ended.

In some embodiments, the processor 501 is further configured to:

obtain the playback video of the live stream by:

splicing the first playback data and the second playback data into the fourth playback data;

storing the fourth playback data; and

creating an index for searching for the fourth playback data.

It can be understood that the server is a server responsible for scheduling and managing the live stream tasks in the live stream system. In specific applications, the server may be a computer, an Internet TV, a tablet device, etc.

The technical solution provided by the embodiment of the application may include the following beneficial effects: in the playing process of the live stream, it is determined whether the anchor of the live stream has the willingness to the playback video of the live stream, and then the playback data is generated in real time for the live stream of which the playback video will be generated, so the generation of the redundant playback data that is not used to generate playback videos can be reduced and the waste of data processing resources and storage resources for the redundant playback data can be lowered compared with the playback video generation way in which the playback data is generated in real time for each live stream.

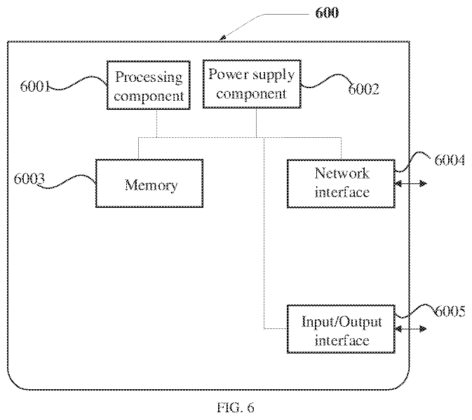

FIG. 6 is a block diagram of a server 600 shown according to another embodiment. Referring to FIG. 6, the server 600 includes a processing component 6001 which further includes one or more processors, and the memory resource represented by a memory 6003 for storing the instructions (e.g., application program) that can be executed by the processing component 6001. The application program stored in the memory 6003 may include one or more modules, each of which corresponds to a set of instructions. In addition, the processing component 6001 is configured to execute the instructions to perform any method for generating the playback video of the live stream provided by the above embodiments of the application.

The server 600 may further include a power supply component 6002 configured to perform the power management of the apparatus 600, a wired or wireless network interface 6004 configured to connect the apparatus 600 to a network, and an Input/Output (I/O) interface 6005. The apparatus 600 may operate based on the operating system stored in the memory 6003. e.g., Windows, Server™, Mac OS X™, Unix™, Linux™, FreeBSD™ or the like.

Furthermore, the application further provides a non-transitory computer-readable storage medium. When the instructions in the storage medium are executed by a processor of a server, the server can perform the method for generating the playback video of the live stream:

obtaining the target data corresponding to the live stream in the playing process of the live stream:

determining whether the anchor of the live stream has a willingness to generate a playback video of the live stream based on the target data:

in the condition that a determining result is that the anchor of the live stream has the willingness to generate the playback video of the live stream, generating the first playback data based on the live stream data generated before a reference time point, and generating the second playback data in real time based on the live stream data generated after the reference time point; wherein the reference time point is a time point at which the determining result is obtained;

generating the playback video of the live stream based on the first playback data and the second playback data after receiving an instruction for generating the playback video of the live stream.

It should be noted that, when the instructions in the storage medium are executed by the processor of the server, the server can perform the steps of the method for generating the playback video of the live stream described in any one of the embodiments of the application.

In an embodiment, a non-transitory computer-readable storage medium including instructions is, for example, the memory 601 including instructions which can be executed by the processor 602 to complete the above method; or the memory 6003 including instructions which can be executed by the processing component 6001 of the server 600 to complete the above method. For example, the non-transitory computer readable storage medium may be ROM, Random Access Memory (RAM), CD-ROM, magnetic tape, floppy disk, optical data storage device, or the like.

In another embodiment provided by the application, there is also provided a computer program product containing instructions, which causes a server to perform the method for generating the playback video of the live stream described in any one of the foregoing embodiments when running on the server.

The above embodiments may be implemented in whole or in part by software, hardware, firmware or any combination thereof. When implemented by software, they may be implemented in the form of a computer program product in whole or in part. The computer program product includes one or more computer instructions. When the computer program instructions are loaded and executed on a computer, the processes or functions described in the embodiments of the application are generated in whole or in part. The computer may be a general-purpose computer, a special-purpose computer, a computer network, or other programmable devices. The computer instructions may be stored in a computer readable storage medium or transmitted from a computer readable storage medium to another computer readable storage medium. For example, the computer instructions may be transmitted from a website, computer, server or data center to another website, computer, server or data center in a wired (e.g., coaxial cable, optical fiber, Digital Subscriber Line (DSL)) or wireless (e.g., infrared, wireless, microwave, etc.) way. The computer readable storage medium may be any available medium that can be accessed by a computer, or a data storage device such as server or data center that is integrated with one or more available media. The available medium may be a magnetic medium (for example, floppy disk, hard disk, magnetic tape), an optical medium (for example, Digital Versatile Disc (DVD)), or a semiconductor medium (for example, Solid State Disk (SSD)), etc.

After considering the specification and practicing the invention disclosed here, those skilled in the art will readily come up with other embodiments of the application. The application is intended to encompass any variations, usages or applicability changes of the application, and these variations, usages or applicability changes follow the general principle of the application and include the common knowledge or customary technological means in the technical field which is not disclosed in the application. The specification and embodiments are illustrative only, and the true scope and spirit of the application is pointed out by the following claims.

It should be understood that the application is not limited to the precise structures which have been described above and shown in the figures, and can be modified and changed without departing from the scope of the application. The scope of the application is only limited by the attached claims.

What is claimed is:

1. A method for generating a playback video of a live stream, applied to a server of a live stream system, the method comprising:
obtaining target data corresponding to the live stream in a playing process of the live stream;
determining whether an anchor of the live stream has a willingness to generate a playback video of the live stream based on the target data;
in a case that a determining result is that the anchor of the live stream has the willingness to generate the playback video of the live stream: generating first playback data based on live stream data generated before a reference time point, and generating second playback data in real time based on live stream data generated after the reference time point; wherein the reference time point is a time point at which the determining result is obtained;
generating the playback video of the live stream based on the first playback data and the second playback data in response to that an instruction for generating the playback video of the live stream is received.

2. The method according to claim 1, further comprises:
in a case that the determining result is that the anchor of the live stream does not have the willingness to generate the playback video of the live stream: generating a third playback data of the live stream in response to that the instruction for generating the playback video of the live stream is received;
generating the playback video of the live stream based on the third playback data.

3. The method according to claim 1, wherein the target data comprises at least one of: behavior data of the anchor of the live stream, or popularity data reflecting a popularity degree of the live stream.

4. The method according to claim 1, wherein said determining whether the anchor of the live stream has the willingness to generate the playback video of the live stream based on the target data, comprises:
determining whether the target data meets a preset playback condition;
in a case that the target data meets the preset playback condition, determining that the determining result is to generate the playback video of the live stream; in a case that the target data does not meet the preset playback condition, determining that the determining result is not to generate the playback video of the live stream.

5. The method according to claim 1, wherein said determining whether the anchor of the live stream has the willingness to generate the playback video of the live stream based on the target data, comprises:
inputting the target data into a preset neural network model;
obtaining the determining result output by the preset neural network model on whether to generate the playback video of the live stream;
wherein the preset neural network model is a model trained by sample target data of a plurality of sample live streams and result labels on whether to generate playback videos corresponding to the sample live streams.

6. The method according to claim 1, further comprising:
obtaining target data corresponding to the live stream in the playing process of the live stream in response to that the determining result is not to generate and the live stream has not ended.

7. The method according to claim 1, wherein said generating the playback video of the live stream based on the first playback data and the second playback data, comprises:
obtaining the playback video of the live stream by:
splicing the first playback data and the second playback data into a fourth playback data;
storing the fourth playback data; and
creating an index for searching for the fourth playback data.

8. A server, comprising:
a processor;
a memory for storing instructions that are executed by the processor;
wherein the execution of the instructions causes processor to:
obtain target data corresponding to the live stream in a playing process of the live stream;
determine whether an anchor of the live stream has a willingness to generate a playback video of the live stream based on the target data;
in a case that a determining result is that the anchor of the live stream has the willingness to generate the playback video of the live stream, generate first playback data based on live stream data generated before a reference time point, and generate second playback data in real time based on live stream data generated after the reference time point; wherein the reference time point is a time point at which the determining result is obtained;
generate the playback video of the live stream based on the first playback data and the second playback data in response to that an instruction for generating the playback video of the live stream is received.

9. The server according to claim 8, wherein the execution of the instructions further causes processor to: in a case that the determining result is that the anchor of the live stream does not have the willingness to generate the playback video of the live stream, generate third playback data of the live stream in response to that the instruction for generating the playback video of the live stream is received; and generate the playback video of the live stream based on the third playback data.

10. The server according to claim 8, wherein the target data comprises at least one of:
behavior data of the anchor of the live stream, or popularity data reflecting a popularity degree of the live stream.

11. The server according to claim 8, wherein the execution of the instructions further causes processor to:
determine whether the target data meets a preset playback condition;
in a case that the target data meets the preset playback condition, determine that the determining result is to generate the playback video of the live stream; in a case that the target data does not meet the preset playback condition, determine that the determining result is not to generate the playback video of the live stream.

12. The server according to claim 8, wherein the execution of the instructions further causes processor to:
input the target data into a preset neural network model; obtain the determining result output by the preset neural network model on whether to generate the playback video of the live stream; wherein the preset neural network model is a model trained by sample target data of a plurality of sample live streams and result labels on whether to generate playback videos corresponding to the sample live streams.

13. The server according to claim 8, wherein the execution of the instructions further causes processor to obtain the target data corresponding to the live stream in the playing process of the live stream in response to that the determining result of the playback determining module is not to generate and the live stream has not ended.

14. The server according to claim 8, wherein the execution of the instructions further causes processor to:
obtain the playback video of the live stream by:
splice the first playback data and the second playback data into fourth playback data;
store the fourth playback data; and
create an index for searching for the fourth playback data.

15. A non-transitory computer-readable storage medium, wherein in response to that instructions in the storage medium are executed by a processor of a server, the server is caused to:
obtain target data corresponding to the live stream in a playing process of the live stream;
determine whether an anchor of the live stream has a willingness to generate a playback video of the live stream based on the target data;
in a case that a determining result is that the anchor of the live stream has the willingness to generate the playback video of the live stream, generate first playback data based on live stream data generated before a reference time point, and generate second playback data in real time based on live stream data generated after the reference time point; wherein the reference time point is a time point at which the determining result is obtained;
generate the playback video of the live stream based on the first playback data and the second playback data in response to that an instruction for generating the playback video of the live stream is received.
